(19) United States
(12) Patent Application Publication
(10) Pub. No.: US 2006/0114099 A1
(43) Pub. Date: Jun. 1, 2006

(54) Door lock and operation mechanism

(76) Inventors: Sheng Bill Deng, Salem, NH (US); Sheng Yung Deng, Salem, NH (US)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 11/330,928

(22) Filed: Jan. 12, 2006

Related U.S. Application Data
(63) Continuation-in-part of application No. 11/026,778, filed on Dec. 30, 2004.
(63) Continuation-in-part of application No. 10/395,628, filed on Mar. 21, 2003.

(51) Int. Cl. G06K 9/00

(52) U.S. Cl. 340/5.53; 340/5.7; 70/277

(57) ABSTRACT

A locking doorknob which recognizes a fingerprint in which the detecting sensor of a fingerprint is installed on the spot of the doorknob that a thumb or other fingers are placed naturally as the door is being opened. The locking doorknob is an electromechanical device which can be powered by a remote electrical power system, specifically by electromagnetic induction through the door latch and strike plate. During operation, a fingerprint is measured and searched as soon as a user grasps the doorknob and, if the fingerprint corresponds to a fingerprint previously input, the door is unlocked and the doorknob can be turned to open the door. In this way, fingerprint recognition and opening of the door are performed at the same time.

This application is a continuation-in-part of U.S. patent application Ser. No. 11/026,778 filed Dec. 30, 2004 and Ser. No. 10/395,628 filed Mar. 21, 2003.

### FIELD OF THE INVENTION

The present invention relates to a biometric locking doorknob or door lever which recognizes a fingerprint and which is installed for example on the door in a house, an apartment or an office. More particularly, the power dependent fingerprint detecting sensor in the doorknob or lever is supplied with the necessary electrical power for operation via a rechargeable battery which is charged via a remote recharging source circuit. According to the present invention, when an authorized person grasps the doorknob or lever, a command is issued to activate or deactivate the locking doorknob or lever accordingly when the persons fingerprint, as received by the fingerprint detecting sensor corresponds to a fingerprint previously input.

### BACKGROUND OF THE INVENTION

Previously, a locking doorknob exists that includes a sensor plate which recognizes a fingerprint input as belonging to a certain user. In such a system, the sensor plate has been installed in a place other than on the doorknob. In that case, when a person touches the sensor plate to measure his fingerprint, the door becomes unlocked if the fingerprint read by the detecting sensor corresponds to a fingerprint previously input.

That prior locking doorknob which recognizes the fingerprint has been applied to various kinds of doors using the above-mentioned function, however, when the prior locking doorknob has been used for an automobile door, the price is substantially high. Furthermore, as mentioned above, the prior invention has been installed separately from a door and a controller so it is not conducive to be installed in a general place such as a house or an office.

In the case of manual doors, there is difficulty in opening the door because the detecting sensor is located separately from the doorknob. Therefore, a person still has to turn the approved through the detecting sensor of a fingerprint. This requires a two-step procedure to actually open the door, which can be cumbersome for the user.

The prior art locking doorknobs include a fingerprint sensor on the door handle or lever, however, the door lock and detecting sensor are powered by a conventional battery which must be replaced from time to time, or by an AC adapter. The known systems are powered by some sort of battery located either in the door or the handle itself in which would necessarily need to be replaced upon depletion which is inefficient, often requires tools and a skilled locksmith, and can lead to failure of the door locking device at inopportune times.

The prior locking doorknob which recognizes a fingerprint has been applied to various kinds of doors using the above mentioned function, however, the prior locking doorknob which have been used are prohibitively expensive and, furthermore, the known handles have been located separately from a door and a controller so it is not conducive to be installed in a general place such as a house or an office.

Also In the known systems, the detecting sensor of a fingerprint is located separately from the doorknob, so that a person has to turn the doorknob in order to open the door after the identification is approved through the detecting sensor of a fingerprint.

### SUMMARY OF THE INVENTION

Thus, in order to solve the above mentioned problems, the detecting sensor of a fingerprint of the present invention is installed on the spot of the doorknob that a thumb is placed naturally. So when a user holds the doorknob, his fingerprint is measured and searched, and if the fingerprint corresponds to a fingerprint previously input, the door is unlocked and the doorknob is turned to open the door. Therefore, fingerprint recognition and opening of the door are performed at the same time.

Another object of the present invention relates to a locking doorknob which recognizes a fingerprint and that is installed on the door in a house, an apartment, or an office. According to the present invention, when a person holds the doorknob, the detecting sensor of a fingerprint, corresponds to a fingerprint previously input.

A further object of the present invention is to provide a biometric fingerprint sensor on a doorknob and system to verify the applied fingerprint to lock or unlock a door.

Yet another object of the present invention is to provide a remote time dependent power source and circuit which supplies electrical power to either recharge a rechargeable battery in the doorknob or to provide power to the verification system and locking and unlocking mechanism.

A still further object of the present invention is to use the principle of electromagnetic induction to create an electrical current in an inductive winding in the door latch through an inductive coupling in the strike plate in order to recharge the battery and power the verification system and locking and unlocking mechanism.

Still a further object of the present invention is to provide an environmental sensor either alone, or in combination with the fingerprint sensor device which would allow the user of a door on one side or the other to recognize at least one of a specified temperature, smoke, fire, gas or other air quality variation or condition on the opposing on the opposite door side.

Another object of the invention is the use of a still camera, video camera or other image acquiring device to capture a reproducable image of a user accessing the door lock or attempting to access the door lock according to a prescribed set of criteria and communicating the image to a computer security network, or real time communication system.

The present invention also relates to a door locking apparatus comprising a door opening device supported on a door, the door opening device having a user verification system for receiving input data comprising; a memory for storing comparison data; a processor for comparing received input data with the stored comparison data and producing an output instruction; a locking mechanism controlled according to the output instruction from the processor; a door latch controlled by the locking mechanism, the door latch having a locked position and an unlocked position; and a remote power source separate from the door opening device for providing electrical power to the operate the locking mechanism and user verification system.

The present invention also relates to a door locking apparatus comprising a door opening device supported in a door, the door opening device having a user verification system for receiving fingerprint input data comprising; a memory for storing fingerprint comparison data; a processor for comparing received input data with the stored comparison data and producing an output instruction; a locking mechanism controlled according to the output instruction from the processor; a door latch controlled by the locking mechanism, the door latch 70 having a locked position and an unlocked position; and a remote power source separate from the door opening device for providing electrical power to the operate the locking mechanism and user verification system; and a second power source integral with the door opening device and directly connected to the locking mechanism and user verification system.

The present invention further relates to a method of operating a door locking apparatus comprising the steps of providing an electrically operated door opening device supported in a door; storing user comparison data in an electronic memory of a user verification system in the door opening device; inputting user data to the user verification system in the door opening device; comparing user input data with the stored user comparison data in a processor; producing an output instruction from the processor to control a locking mechanism connected to a door latch having a locked position and an unlocked position; and supplying electrical power to operate the locking mechanism and user verification system from a remote power source separate from the door opening device.

### BRIEF DESCRIPTION OF THE DRAWINGS

The invention will now be described, by way of example, with reference to the accompanying drawings in which:

FIG. 16A is a perspective view of the support housing containing the electrical, electro-mechanical and mechanical elements of another embodiment;

FIG. 16B is a perspective-exploded view of the electrical, electromechanical and mechanical elements of the door locking apparatus which are fully contained within the circular support housing and within the door aperture;

FIG. 17 is a cross-sectional view of the locking and unlocking mechanism of the present embodiment;

FIG. 18 is a perspective-exploded view of the components of the locking and unlocking mechanism of the present embodiment;

FIG. 19A is a perspective view of the locking and unlocking mechanism of the present embodiment in a locked state;

FIG. 19B is a perspective view of the locking and unlocking mechanism of the present embodiment in an unlocked state;

FIG. 20A is an elevational side view of the bolt mechanism in a retracted state;

FIG. 20B is an elevational view of the bolt mechanism in an extended state; and

FIG. 21 is an exploded perspective view of the bolt mechanism.

### DETAILED DESCRIPTION OF THE INVENTION

In general, and observing FIG. 1, the locking doorknob 1 or lever and operation system and mechanisms of the present invention will now be described. As an initial matter, the locking doorknob 1 consists of a first knob 10 or lever on one side of a door 2, and a second knob 30 or lever on a second opposing side of the door 2 as is typical and conventionally known for opening and closing a door. The first doorknob 10 or handle is connected with and supported in a doorknob hole 4 in the door 2 by a first doorknob body portion 12 and the second doorknob 30 or handle is also connected with and supported in the doorknob hole 4 in the door 2 by a respective second doorknob body portion 32. A respective first and second cover plates 14, 34 are interspaced between the respective handles and the body portions, and as is well known in the art, covers the exposed body portions on either side of the doorknob hole 4 mainly for purposes of aesthetics.

A knob operations shaft 6 which defines an axis of rotation of the first and second doorknobs 10, 30 or handles substantially through the center of the door knob hole 4 is connected between the first and second doorknobs 10, 30 or handles. The operations shaft 6 extends through a central passage in the first doorknob body support, through the doorknob hole 4, and through the second doorknob body support to engage the second doorknob 30 or handle on the opposing side of the door 2. The operations shaft 6 transmits the turning action of either of the doorknobs at least to a lock mechanism 50, which in turn, if unlocked according to a positive indication from the fingerprint scanning plate 16 and related processor 18 as will be discussed in further detail below, provides for retraction of the door latch 70 and opening of the door 2.

As is also known in the art, the first and second doorknobs 10, 30 or levers are generally attached via their respective body portions by screws or a bolt mechanism which allow a certain axial variance between the first and second body portions and knobs 10, 30 along the axis of rotation A. The first and second doorknobs 10, 30 themselves are provided with axially variable keys to provide variable axial engagement of the ends of the operations shaft 6 in order to accommodate different widths, i.e., thicknesses, of doors. As these features are well known in the art, no further discussion is provided herein.

A door latch hole 72 is provided along a free edge of the door 2, as opposed to the hinged edge of the door 2, and formed axially perpendicular to the axis of rotation A and communicating with the doorknob hole 4. Inside the door latch hole 72 is situated a door latch bolt 74 having, at one end, a connection mechanism 76 for connecting with the lock mechanism 50 connected to the operations shaft 6, and an opposing free end engages and disengages with a strike plate 100 in the door frame in accordance with a biasing spring in the door latch bolt 74 and the locking and unlocking of the lock mechanism 50.

When the lock mechanism 50 is unlocked, the rotation of a doorknob 1 or handle, and the relative rotation of the operation shaft 6 causes the door latch bolt 74 to withdraw from an outwardly biased position, usually engaging the strike plate 100 when the door 2 is closed, and retract substantially within the door latch hole 72. This enables the door 2 to swing freely on its hinged edge and open.

As discussed above and as is well known in the art, the door latch bolt 74 may be springably biased outwardly relative to the free edge of the door 2 so that upon the user releasing the rotation of the doorknob 1 or handle the door latch bolt 74 is springably returned to the outwardly biased position. Upon the door 2 being closed, the door latch bolt 74 self-engages with the strike plate 100 due to the inertia of the closing door 2 and a sloped surface on the free end of the latch bolt 74 to facilitate re-engagement with the strike plate 100.

The latch bolt 74 may also be of the dead bolt type where no springable bias is provided and mere rotation of the handle in either direction is necessary to engage and disengage the latch bolt 74. In either event in the present invention, the strike plate 100 and the door latch bolt 74 are provided with an inductive coupling for causing an induced current to be generated in an inductive winding provided in the latch bolt 74. The inductive winding in the latch bolt 74 is connected to a charging circuit with connects with a rechargeable battery 38 generally positioned in either of the door handles. The induced current, as described above, is generated according to the principles of electromagnetic induction by an electrical source current i in a second inductive winding 80 located in conjunction with the strike plate 100. A further description of these features is provided below.

Turning now to FIG. 2, a further description of the biometric operation of the present invention is provided. In at least one of the first or second doorknobs 10, 30 or handles, shown here in conjunction with the first doorknob 10, the fingerprint scanning plate 16 may be generally located on the extreme end in a position coincident with the axis of rotation A of the doorknob handle. This is the position where a person's thumb would generally or easily be placed during operation of the doorknob 10, 30 or handle. The fingerprint scanning plate 16 is of a type which is generally commercially available, for instance the TouchChip® as provided by STMicroelectronics®. The scanning plate 16 is connected via an electrical connection 22 which extends within the first doorknob 10 from the scanning plate 16 to a processor module 18 located substantially between the first and second doorknob body support members 12, 32 and within the doorknob hole 4.

The fingerprint scanning plate 16 is thus capable of reading a fingerprint as input and sending the fingerprint as acquired data to the processor module 18 whereupon it can be compared with saved fingerprint data previously input, so as to verify or authorize a respective unlocking or locking of the door locking mechanism 1.

In order to provide the known fingerprint data to the fingerprint processor module 18, a control pad 20 is provided with the first cover plate 14. An opening is formed in the cover plate 14 so that a user can input, via the control pad 20, the necessary commands to operate the control pad 20 in the body support flange. The control pad 20 may be of the LCD type or a dial pad as are well known and can be provided with keys or buttons as a direct input device for inputting the data in cooperation and the desired fingerprints for authorized users, as well as for deleting or otherwise changing desired fingerprints and related data in the processor 18. An electrical connection 22 extends between the control pad 20 and the processor 18, and a decoder device 19 can be situated between the control pad 20 and the processor 18 having a memory to functionality to unlock the locking mechanism 1 where a positive identification occurs.

Observing FIG. 3, the processor is held at least partially by a mating slot 24 in the first body portion 12 which is located as centrally as possible with respect to the door hole 4 to provide as much room as possible for the processor 18 without interfering with the mechanical workings of the operations shaft 6 and lock mechanism 50 and the doorknob securing bolts and engagement bores.

A code, when provided to the control pad 20, would enable the user to input a fingerprint, or a number of fingerprints, as data to be stored in the fingerprint processor module 18. If the fingerprint scanning plate 16, in a normal operation mode, sensed a stored fingerprint, then those persons authorized, via stored fingerprints, would be able to lock or unlock the door locking operation mechanism 50. In addition, a code could also be provide to override the fingerprint matching function of the processor 18, for example, in the case of the fingerprint scanning plate 16 failing or unable to read an applied fingerprint. A further discussion of the processor function is provided below.

FIGS. 4 and 5 show the second doorknob 30 provided with an environmental sensor plate 36 which can be one of a variety of temperature sensing devices including a thermochromic sensor which changes color depending upon a level of temperature to which the sensor 36 is exposed. More preferably the sensor 36 is provided with a thermocouple which relays an electrical signal via a second electrical connection 42 to the processor 18 and then to the display of the control pad 20 to inform a user of the temperature by either visual or audible means. The sensor plate 36 is supported between the second cover plate 34 and the second body portion 32 and may be provided with any number of different environmental sensors, for example; temperature, smoke, fire, gas or other air quality variation or condition on the opposing on the opposite door side.

Also in the second doorknob 30 is provided a battery 38 for powering the sensor plate 36 and processor 18. The battery 38 is situated substantially centrally within the doorknob 30 and because it is a rechargeable battery 38 is connected to the charging circuit from the induction coil in the latch, a further description of which is provided below. The battery 38 sends power to the processor 18 and biometric fingerprint scanning plate 16 and the electromechanical locking mechanism 50 via the second electrical connection 42.

It is well known in the art that a fingerprint processor module 18 and biometric fingerprint, as discussed above, must be provided with some sort of power source in order to generate the data and control functions as described above. As previously discussed, the present invention utilizes a battery 38, namely a rechargeable battery, positioned in one of the first or the second doorknob 10, 30 or handle as one source of electrical power to operate the processor module 18 and fingerprint scanning plate 16. A positive and negative leads 64 are provided from the rechargeable battery holder to the processor module 18 to provide the required electrical power. leads 64 are provided from the rechargeable battery holder to the processor module 18 to provide the required electrical power.

The second doorknob 30 is also provided with an on/off button 44 for essentially manually, enabling and disabling the entire system from the second side of the door 2. The on/off button 44 is situated in a supporting ring 46 in the center end of the second doorknob 30, as is typical in the art, and communicates with the locking mechanism 50, via the second electrical connection, to enable or disable the locking mechanism 50. The on/off button 44 is usually situated on the inner side of a door 2 to facilitate the user disabling the locking mechanism 50 once they have entered the room and intend to stay there for a period of time. It is also to be appreciated that the supporting ring 46 may be an indicator device, for example a luminous dial which is connected to the environmental sensor 36 and which lights or changes color in accordance with a desired environmental indication from the sensor 36. It is to be appreciated that a similar type indicator ring 46 may also be used with the first doorknob 10 to support the fingerprint scanning plate 16 and provide the same indication on the first side of the door 4.

FIGS. 6 and 7 show the lock mechanism 50 and the latch. The lock mechanism 50 is a conventional electromechanical solenoid actuated mechanism which is connected with the processor. In a first position, the lock mechanism 50 interrupts the interaction between the operations shaft 6 and the latch so that a turning of the doorknob fails to retract the door latch 70. When a certain signal is sent to the lock mechanism 50 that a positive fingerprint identification has been made by the processor 18, the lock mechanism 50 is actuated into a second position to allow the rotation of the doorknob and operations shaft 6, which acts on the latch operations member connected thereto, to retract the door latch bolt 74 and the central lock pin 73 incorporated therein from the strike plate 100 and within the door latch hole 72.

The central lock pin 73 is inserted and supported within a bore of the latch bolt 74. A portion of the lock pin 73 can be flush with or extend slightly from the end of the bore along the sloped end surface of the latch. The lock pin 73 is provided also with an induction coil which, due to a magnetic field M created by the source coil 102 in the strike plate 100, to be further discussed below, has an electrical current induced i₂ therein. In an embodiment of the present invention the central lock pin 73 can be made of a magnetic material to assist in focusing of the magnetic field flux M with respect to the induction coil 80. In an embodiment of the invention the coil 80 can be substantially wrapped around the magnetic material to facilitate such coupling. The induction coil 80 sends the induced current i₂ via electrical leads 64 to the charger circuit which, in turn, relays the appropriate electrical charge through the second electrical connection to the rechargeable battery 38 as well as directly to the processor 18. In normal operations, the induction coil 80 provides the processor 18 and lock mechanism 50 with operating power. In a power failure mode, the battery 38 can provide the necessary power to the system.

The entire door latch 70, lock pin 73 and charger circuit is generally supported and encased within a door latch housing 71 which holds all the discussed elements together and facilitates the mounting of the door latch 70 within the door latch hole 72. A latch guide plate 77 is usually placed over the end of the housing once the housing is mounted in a door hole for both functional and aesthetic purposes to provide further support to the door latch 70 as well as facilitate engagement of the door latch 70 with the strike plate 100.

FIG. 8 shows the source coil 102 in the strike plate 100. The strike plate 100 is, as well known in the art, incorporated in the door frame of a door 2, and in axial alignment with the door latch bolt 74 in the door 2. The strike plate 100 is provided with a depression or cavity for catching the door latch 70. The walls 106 of the strike plate 100 cavity are, in the present invention, provided with an induction source coil 102 incorporated therein. Because the source coil 102 is incorporated with the strike plate 100 in the door frame of the door 2, common electrical wiring may be easily connected to the source coil 102, via leads 64, energized by typical electrical service circuits either commercial or residential usually incorporated in the walls 106 of the building. As can be appreciated by those of skill in the art, when the door 2 is shut, the free end of the door latch 70 is captured in the cavity in the strike plate 100 and the induction coil 80 in the lock pin 73 is arranged substantially adjacent the source coil 102 in the strike plate 100.

In order to recharge the battery 38, the present invention utilizes an inductive power transmission coupling as discussed above. By way of example, FIG. 9 shows a pair of inductive coils 80, the first situated in the door latch bolt 74 and the second located in the strike plate 100. Electrical induction i₂ involves the use of providing and generating an electrical source current i in one coil which is unattached but located substantially adjacent to a second inductive coil 80. The proximity of the electrical circuits where the second inductive coil 80 is the source coil 102 and is provided with power generates a magnetic field M which induces an electrical induced current i₂ in the first source coil 102. As seen in FIG. 9, the principle of inductance reveals that if a conductor supplied with a time dependent source current is near some other conductor, than the changing magnetic field M of the former can induce an electromagnetic force (EMF) in the later. Thus, if a time dependent source current in one conductor can induce an induced current i₂ in another nearby conductor. For instance, considering the present case where the second inductive coil 80 in the strike plate 100 carries a time dependent source current, it generates a magnetic field M wherein the flux lines of the magnetic field M, i.e., at least a portion of them, pass through the first coil 102 located in the door latch bolt 74 thus inducing the EMF in the first coil 102. Thus the time dependent EMF produces the induced current i₂ in the latch bolt coil 74 which is used to recharge the battery 38 via a pair of conducting wires extending from the first coil 102 in the latch bolt 74 to the battery 38 recharging unit in the second doorknob 30 or handle.

The magnetic field M strength produced by the source current in the strike plate coil 102 is proportional to the source current and is, therefore, dependent thereon and depends substantially on the sizes of the coils, their distance and the number of turns in each coil. Additionally, both the source and induction coils 80 should usually be aligned along the door latch axis at an angle commensurate with the angle of the sloped surface of the door latch bolt 74. Such an angle of the coils 80 is generally necessary to ensure the magnetic field M lines generated by the source coil 102 appropriately cross the induction coil 80 to generate the appropriate induction current therein. As such geometry and the physical elements of the mutual inductance and differently sized coils is well known in the art, it is readily apparent that when the strike plate 100 and the latch bolt 74 are engaged and the respective second and first coils 80, 102 are closely aligned, a desired induced current i₂ can be produced in the first coil 102 to recharge the battery 38, and thus power the processor 18 and locking mechanism 1.

In order to ensure that a desired induced current is induced in the induction coil 102 in the door latch 70, portions of the latch bolt 74, or the entire latch bolt 74, and even the central locking pin, may be made from a non-ferrous material to ensure that the magnetic field M lines are not interrupted between the source and induction coil i₂. The source coil 102 could also be placed on an outer portion of the door latch bolt 74, for example in grooves thereon, to better expose the induction coil 80 to the magnetic field M. The induction coils might also be placed separate from the latch bolt 74 and within the door 2 or the door latch hole 4 itself. For example, where the induction coils 80 are provide within the door latch hole 72 and around the outside of the door latch housing 71, the housing 71 and door latch 70 act as a core which could improve the electromagnetic induction efficiency of the present invention, and the door 2 itself, when made of a non-ferrous material would not interfere with the magnetic field lines of the source coil 102.

Referring now back to FIG. 4, the illustrated door handle 1 also comprises at least a first temperature sensor plate 36 sandwiched between the second body portion 32 and the second cover plate 34. By way of example, the sensor plate 36 be formed of a temperature sensitive material which changes color if its temperature exceeds a certain level. Such chemical temperature sensors are widely used and readily available and thus are not described in further detail here. With the particular embodiment illustrated, the senor plate 36 can be provided as any number of environmental senors 36 for air quality/condition, gas detection, heat, fire and smoke detection as well.

In use, the device functions by registering the desired environmental conditions and relaying them, via the second electrical connection, to an indicating device, i.e., visual, audible or otherwise, on the control pad 20 or in the processor 18 itself to alert a user. Thus, if the condition on one side of the door 2 exceeds a predetermined level, such level detected by the sensor 36 is displayed or audible on one or either side of the door 2 to indicate this situation. By way of example, the device allows one to observe a gross temperature change on an opposite side of the door 2. Heat is, therefore, not transferred through the thermal conductor independently from one room to the other.

The device is primarily used for fire detection. If one is standing in a room of normal temperature which would not in itself cause a color change in the device and if there were a fire in the adjacent room which caused the temperature in the adjacent room to exceed the predetermined temperature level for color change such as, for example 135° F., then the observer in the room temperature room would observe the color change and know that the adjacent room was extremely hot and possibly on fire. Such color change will occur in the device irrespective of the lower temperature in the room in which the observer of the color change is in. The device does not determine the relative temperature between the two rooms but is useful when there is an extreme difference in temperature which causes a color change to occur in the indicator located in the room that is not of higher temperature.

The system for verifying fingerprints and the associated functionality of the processor 18 and operation of the locking controller operation based thereon will now be described with reference to FIGS. 10 and 11. The control pad 20 can be an LCD touch pad or conventional button dial pad as is known in the art.

The control pad 20 is used to select different operation modes, some examples being: Enroll, Erase, Enter Passcode, Reset System, System Log, Set Time, Always Lock, etc. The control pad 20 can also be used as a backup system to unlock the system (door lock) in an event of failure in the fingerprint processing subsystem. Ideally, the control pad 20 can have an LCD or similar type display panel which turns Green/Red to indicate Unlocked/Locked when a user post the finger on the fingerprint sensor plate chip and the print is verified by the system. A yellow light should automatically turn-on if any of the buttons on the control pad 20 are pushed. Also a timer and temperature display on the control panel is an option to the system.

A battery life indicator may also be necessary. In a normal condition, the battery 38 should always be fully charged because the door 2 would generally tend to be mostly in the closed position. In view of the inductive power aspect of the present invention, which can directly power the processor and locking mechanism as well as charge the battery 38, the battery 38 can either be used to power the operation of the processor 18 and lock mechanism 50 or the battery 38 can be used as a backup in an event of power outage for a long period of time.

The system shown in FIG. 10, includes the control pad 20, a decoder and memory 19, the fingerprint scanning plate 16, the processor module 18, the inductive charger unit and a lock mechanism 50 controller. The control pad 20 can be of any type known in the art. By way of example, the control pad 20 is provided with a number of input buttons or keys. Mode can be chosen by a mode button on the control pad 20 to select different menus of operations. The basic mode of operations are: Enroll, Erase, Enter Passcode, Reset System, System Log, Set Time, Always Lock, although other modes can be contemplated as well. An on/off button, 0/1 is also provided to turn-on the system. This button is optional since the fingerprint sensor plate chip may have an auto detection to turn-on the system once a finger tip is present to the sensor plate chip. A user touching any of the control pad 20 buttons would active (turn-on) the system. The system should automatically standby or even turn-off after “XX” number of seconds and retain its original state. A Confirm Select, Sel, is another one of the buttons available for the control pad 20 to confirm the selections on the LCD display. This button acts like an “Enter” button on the keyboard. Navigate keys may also be provided on the control pad 20 to help navigate through the control pad options. These buttons work along with the Sel button to select an object on the control pad display. The system should also have a factory default setting. The Super user (owner) should be able to reset the default setting through the control pad 20 once the system is installed.

Other inputs to the system, i.e., the processor, include; Fprint which inputs a user's fingerprint via the fingerprint scanning plate 16: Fprint is the human fingerprint applied to the sensor plate chip. A knob switch button, shown as a command BSwitch, is a switch button located on the second doorknob 30 to manually lock or unlock the system by providing a signal directly to the lock mechanism controller 50.

Outputs from the system, i.e., through the processor and locking mechanism controller 50 includes a dead lock plunger command to cause the latch to act as a locked deadbolt once the door 2 is closed and the system is locked. This can also be replaced by a mechanical plunger. Another output is an Un_lock output to Lock/Unlock the System: Un_lock is an output from the processor 18 and controller to the solenoid to electronically lock or unlock the lock mechanism 50. A time Output to the LCD control pad 20 to display current time. Temperature can also be an output to the LCD to display the current temperature on one side of the door 2 or the other.

Heat and Smoke Detection or other environmental conditions can be sensed and output to the control pad 20 to indicate a fire or smoke event on the other side of the door 2.

The control pad 20 is connected to the decoder, via a I2CBus or any other known electrical connector, which is the encoded LCD data signal, an SCL is the clock for the 12C data signal and Power and Ground for the LCD where VSS is ground, Vdd Power for the LCD logic and VLCD supply voltage for LCD (contrast adjustment). An Interface Bus Ibus is a bus of data that communicates between the Processor module 18 and the decoder.

The fingerprint scanning plate 16 works in conjunction with a fingerprint Template which is the soft copy of the user's template that the scanning plate 16 reads from the human fingerprint. A dial pad verify match, Dmatch, is an internal signal where passcode is matched with one of the user's passcode in memory. This signal can be replaced with FPMatch by Software.

FPMatch is an internal signal where Fingerprint and/or Dialpad passcode is matched. This signal drives the solenoid of the locking mechanism to unlock or lock the system. The inductive charger unit is provided with an internal signal PActive which turns the latch into a deadlock.

Turning to the functional diagrams of FIGS. 11 and 12, the enrollment function whereby a main user can add, remove or reset the stored fingerprint data in the processor 18 is shown. The main user initiates the system at step 200 by selecting a mode button from at least those of add, remove or reset. The processor 18 thus recognizes that either addition fingerprints are to be added at step 202; certain fingerprints are to be removed at step 204; or the entire system is to be reset at step 206. After selection of the appropriate mode, the main user is required to input at least one of a fingerprint and a password or code through a respective scanning plate 16 and control pad 20 at step 208, knowing that the system understands the authorized main user. Once the desired mode has been entered in the main user's fingerprint and/or code have been verified by the processor at step 201, the processor moves through one of either step 202; the addition of users, or step 204; the removal of certain users, or step 206 which resets the entire system.

Following for the addition of users or the removal or the reset which of these steps is followed by a verification of either of the addition, the removal or the confirmation of the system reset via steps 208, 210, 212, these functions are confirmed and through step 220 can be returned to the start.

Turning now to the functionality processor and of the data handling functions, as shown in the function diagram of FIG. 12, when data is input from the detecting fingerprint scanning plate 16 of a fingerprint, step 230, the system wake up 202 initiates the processor 18 and the data is interpreted whether or not it is compatible with the fingerprint data previously stored in the memory. After that, if the data is compatible with the data previously stored in the memory, the door 2 is to be unlocked step 236 or else, the process returns to the start via step 238.

On the other hand, in the case where no fingerprint data is input at step 230, if the code is input by the buttons on the LCD control pad 20 at step 240, with wake-up at 242, the code input is interpreted whether or not it is compatible with the code previously input in the memory step 244. Also, when the code is compatible with the number previously input in the memory (i.e., the answer to step is “yes”), the door 2 is to be unlocked at step 246. Otherwise, the process returns to the start at step 238.

Thus, when a person whose fingerprint has previously been input into memory holds the doorknob to open the door 4, and puts his finger on the scanning plate 16 recognizing fingerprint of the detecting scanning plate 16 of a fingerprint, a lamp which is formed in the doorknob cover plate turns on and the door 2 is to be opened.

As an additional feature, in the case that a certain time elapses, the entire process is to be reinstated in order to restrain another's entrance.

In the normal operation mode, a user places their hand on the doorknob handle 1 with their thumb adjacent the fingerprint scan plate 16 which data is read by the processor module 18 and compared to the known data. Where the data finds a matching data to the operator's thumb or fingerprint, the processor module 18 sends a signal to permit operation, i.e., rotation of the handle and unbiasing of the latch mechanism and thus operation of the door 2. In the instance where no comparative data with the operator's finger or thumbprint is determined, the affirmative signal to operate the door handle 1 is not sent and the door 2, in general, will remain in a locked state.

In another embodiment of the present invention shown in FIGS. 13-15, an image capture device 15 can be utilized in combination with the doorknob and lock of the present invention to observe, and record persons utilizing or attempting to utilize the door lock. For example an image capture device 15 such as a digital camera, video camera or closed circuit TV receiver communicates with the processor module 18 to facilitate identification of person(s) accessing or attempting to access the doorknob 1. By way of example, the processor 18 may be programmed to obtain and save an image, or video of any person gaining or attempting to gain access through the door by using the finger print sensor 16 on the door lock. The processor module 18 may also be programmed to store the acquired image or video of the person using the sensor and door lock with the appropriate date and time for later retrieval as a data file in the processor 18. Alternatively, the processor 18 can be provided with network interfaces 13, hard wired or wireless, e.g. wifi, to receive and transmit information to and from remote networks, display devices etc. By way of further example, upon capture of an image by the image capture device 15 the image can be sent to an image display device 17 on an opposing side of the door lock, also for instance to a cellular communications device remote from the door knob for immediate scrutiny, and also to a local area computer network 21 for current or future security purposes.

It is to be appreciated that the camera or other image capture device 15 can be mounted in the lockset faceplate and body as shown in FIG. 1 4A, the door knob as in FIG. 14B, or directly in the door itself similar to a conventional security peep hole as seen in FIG. 14C. Also, an LCD display 17 or other display known in the art could be placed on the inner locking doorknob plate to permit monitoring of the outside condition and environment on the opposing side of the door as shown in FIG. 15. Besides the date and time of the acquired image, the data acquired by the fingerprint sensor 16, for instance finger print data, may also be associated with any acquired image. Of course the processor 18 can be programmed to acquire images and transmit only in certain circumstances, for instance where the processor cannot verify an operator's fingerprint data, or if there is any attempt to bypass the code word input or fingerprint data input, i.e., forced entry through the door.

It is also to be appreciated that a controller for the image capture device 15 may be implemented in the processor 18, or the controller may be an essentially independent device 15a as shown in FIG. 13, or even a separate stand alone feature which can be programmed independent of the processor 18 and may or may not communicate, i.e., receiving and transmitting data through the processor 18.

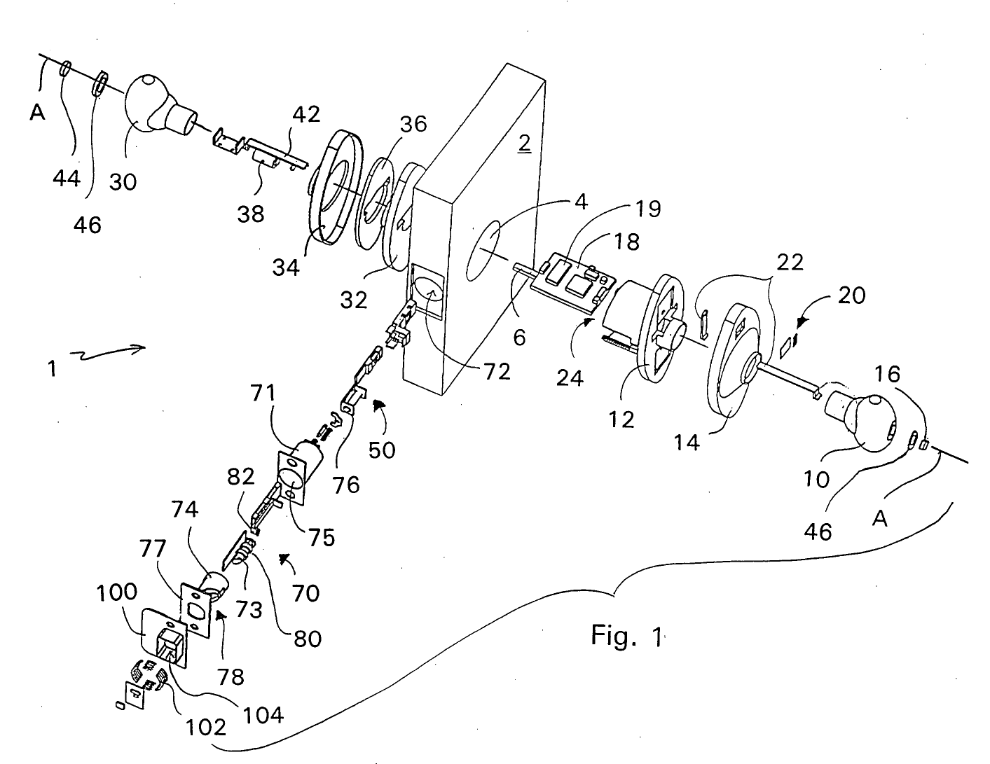

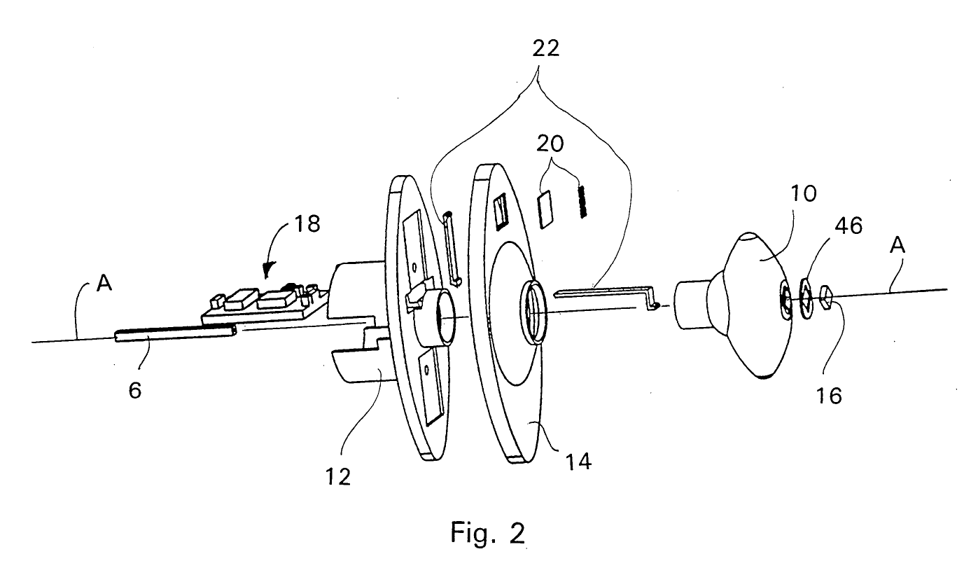

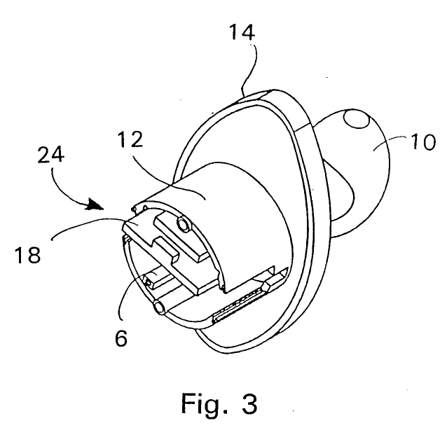

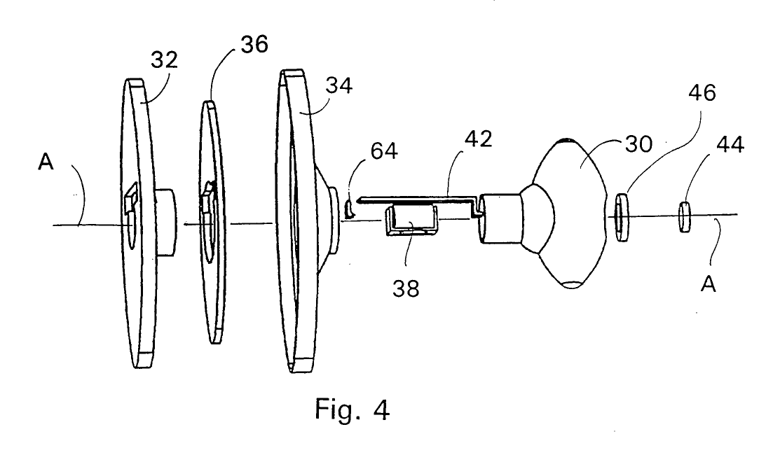

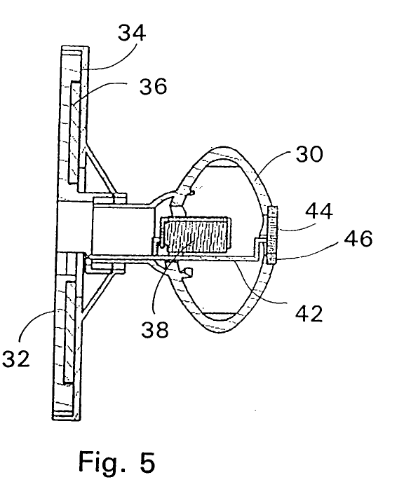

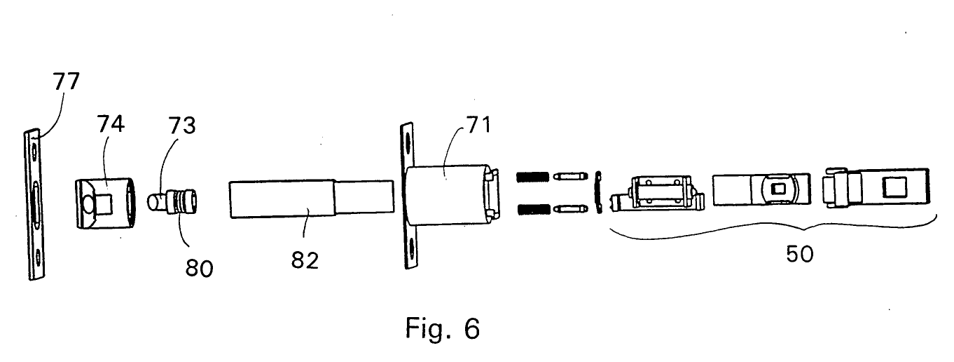

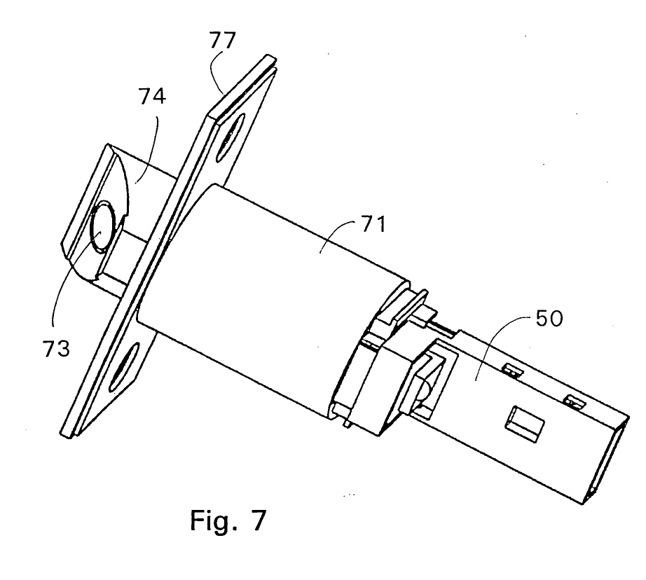

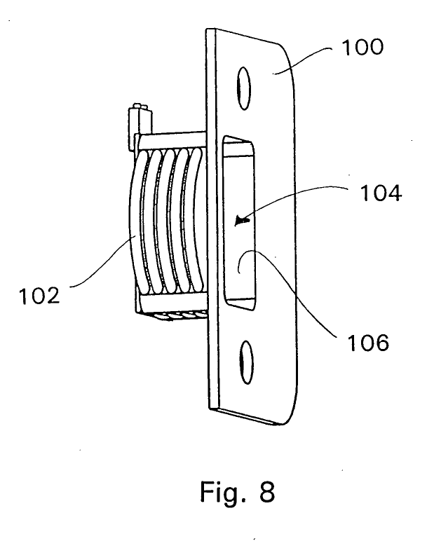

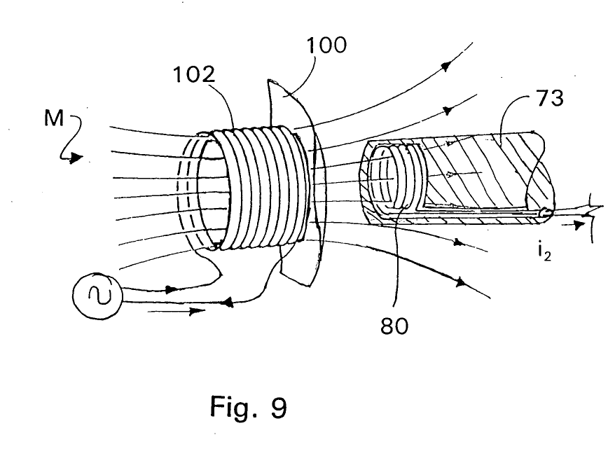

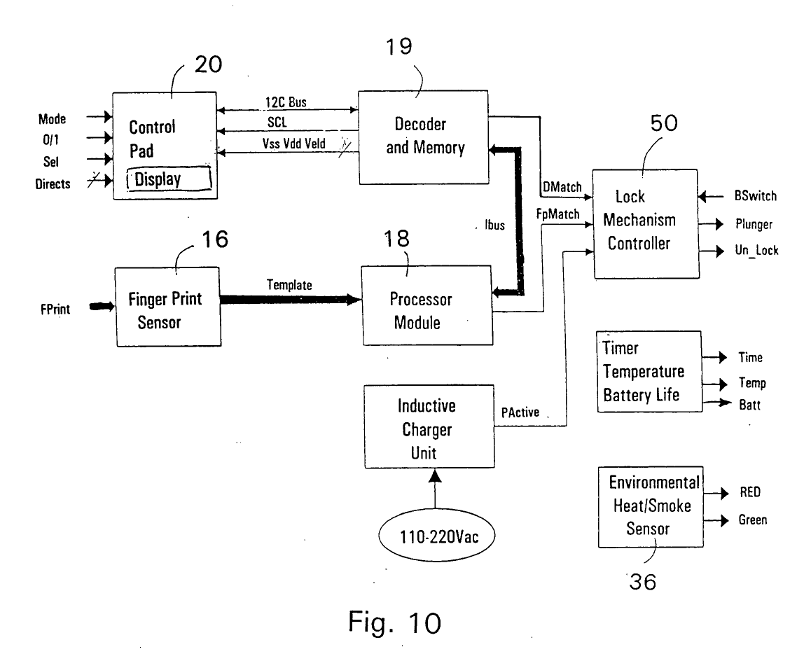

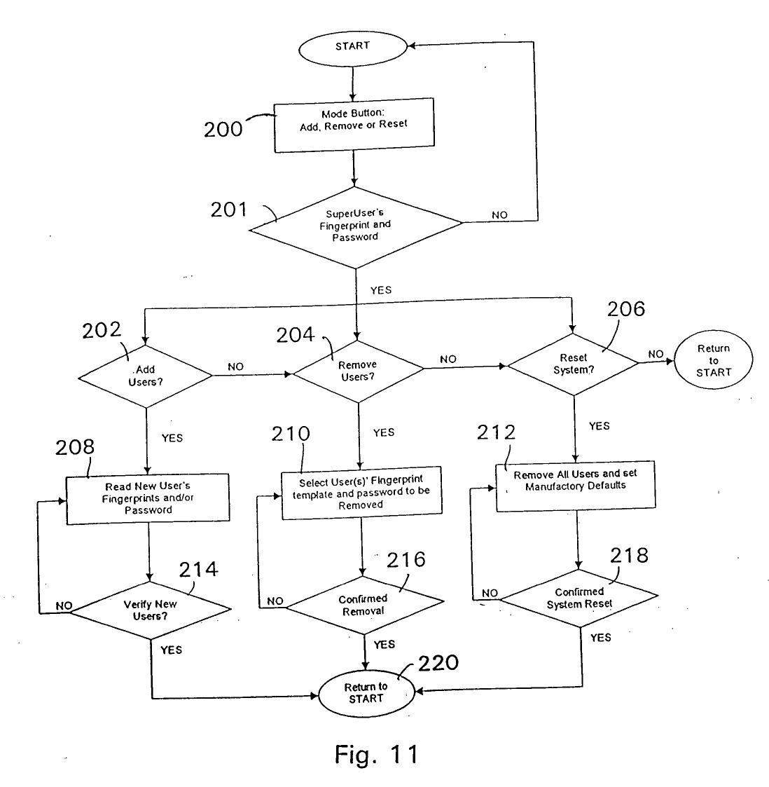

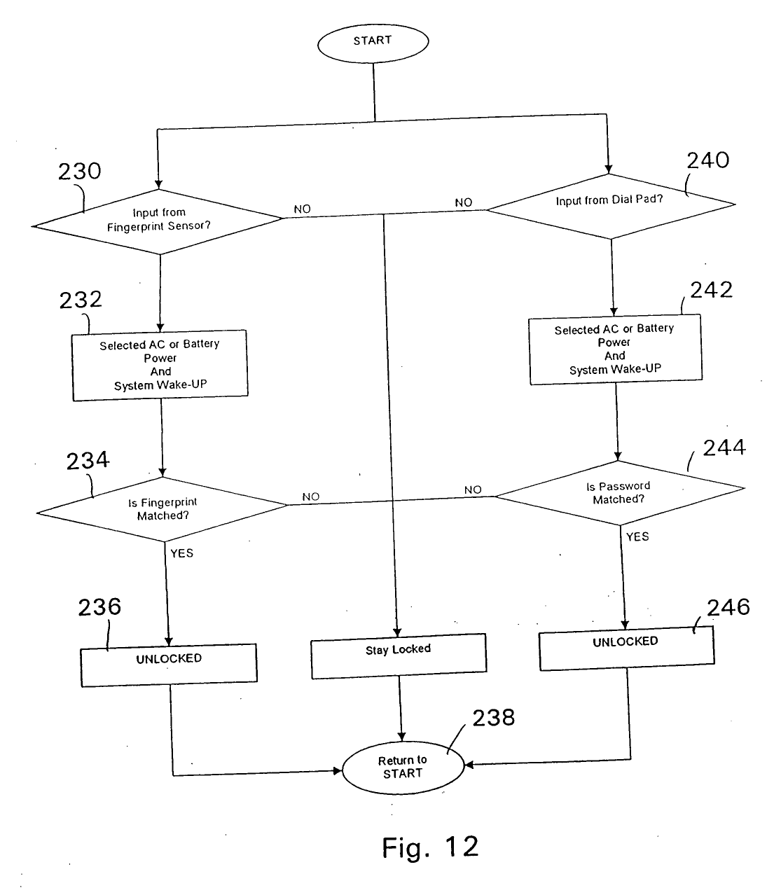

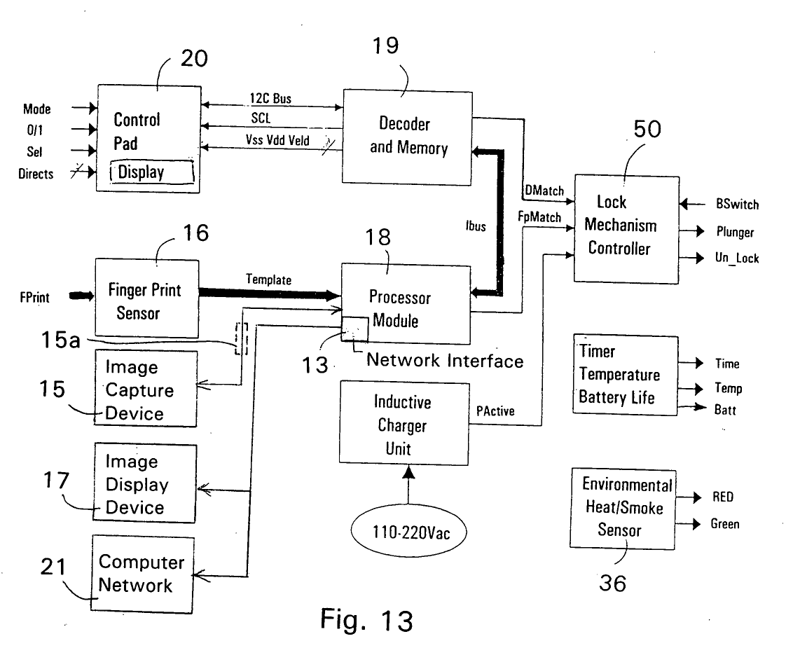

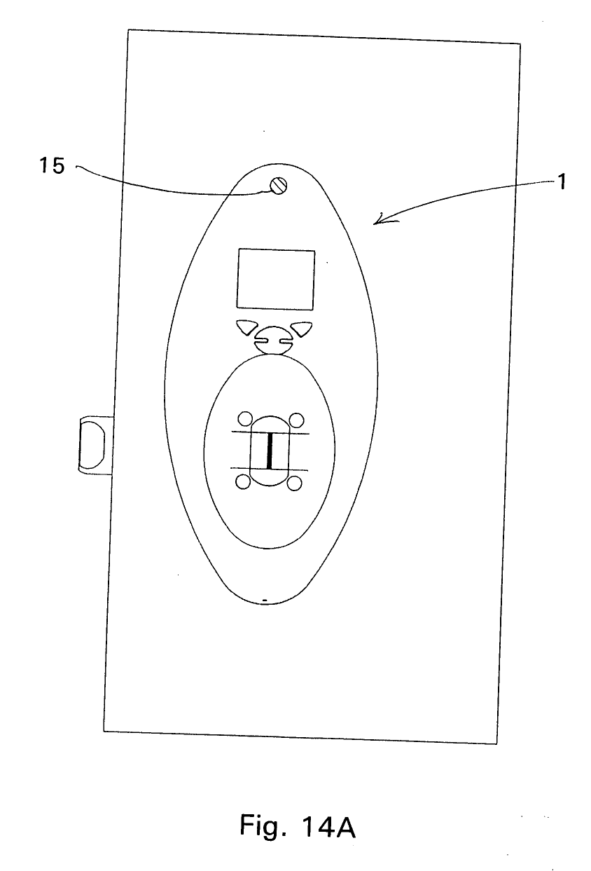

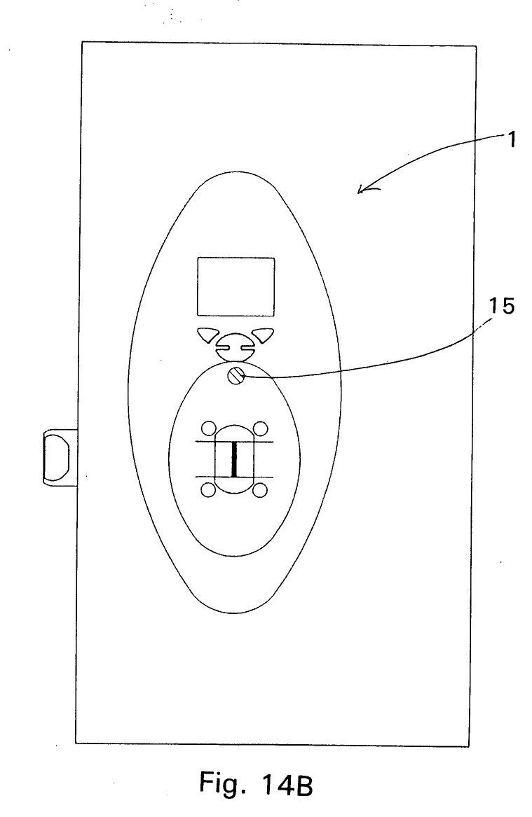

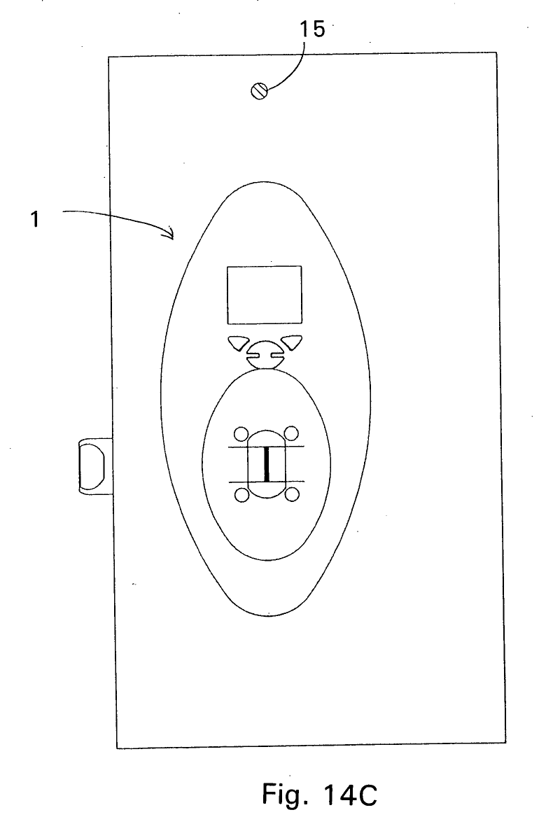

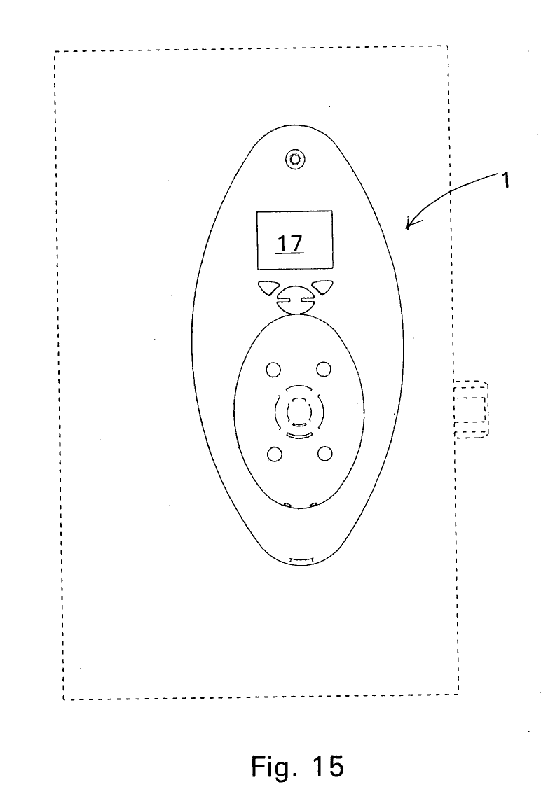

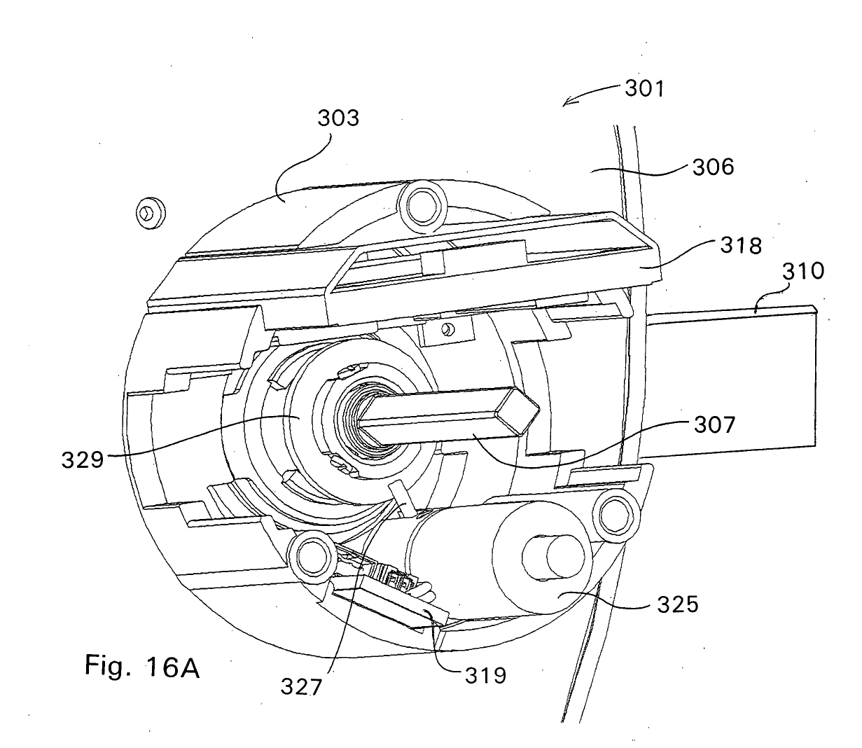

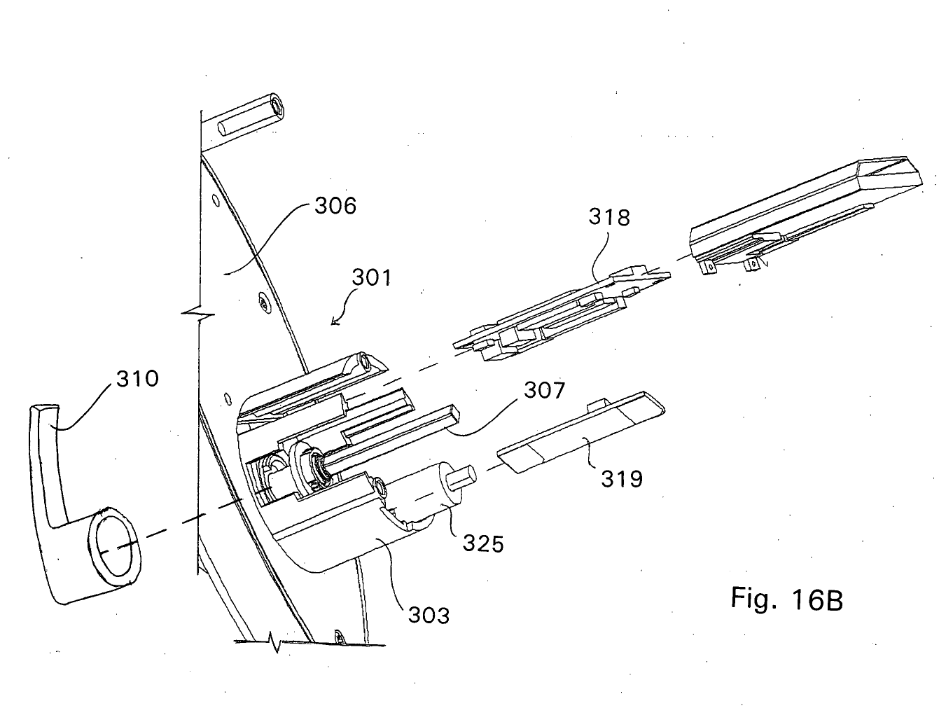

Turning now to FIGS. 16A, B, a brief description concerning the various components of a further embodiment of a door locking apparatus 301 of the present invention is now provided. In most instances, like reference numerals for previously discussed elements are utilized for the sake of continuity with the previous description.

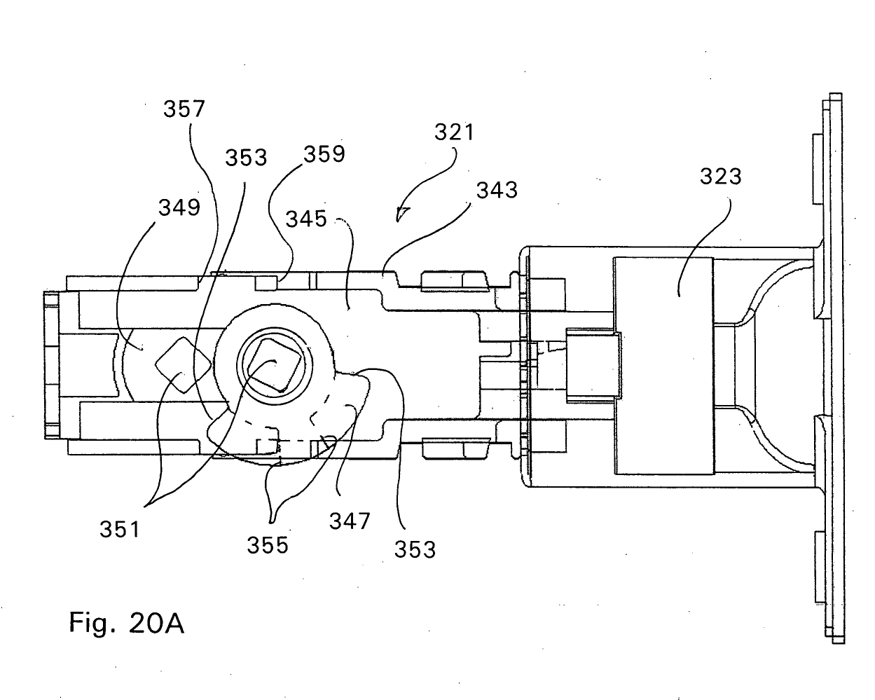

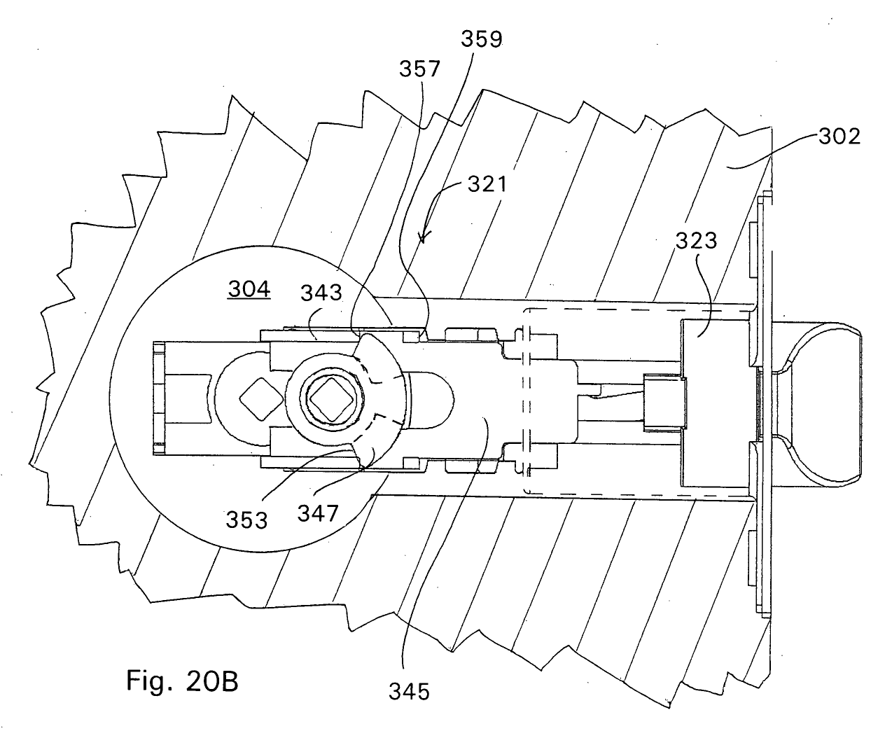

It is important to note that all the major electrical and electromechanical components are located within the circumference of a substantially circular support housing 303 of the door locking apparatus 301. The door locking apparatus 301 is supported on the door 302 by the support housing 303 extending through a standard size door knob hole or aperture 304 in the door. Accordingly, the support housing 303 is conventionally sized in the range of about 2 to 3 inches in diameter, so as to fit within such standard sized door apertures 304. This significant improvement over the known electronic door lock systems specially arranges and sizes all the mechanical and electronic components of the door locking and unlocking operation in a unique and novel arrangement so as to achieve the respective interaction of these components with the bolt mechanism 321 (see FIGS. 20A, B) all within the about 2-3 inch circumference of the support housing 303.

Within this circumference of the support housing 303 is situated an actuator shaft 307 which is generally centrally positioned within the support housing 303 so that the actuator shaft 307 connects between a handle, knob or lever 310 on at least one side of the door 302 and the bolt mechanism 321. As is conventionally known, the actuator shaft 307 connects between the handle, knob or lever on each side of the door 302, and connects to or passes through a bolt mechanism 321, so when the door handle, knob or lever 310 is turned, the actuator shaft 307 is cooperatively rotated and similarly the bolt mechanism 321 operates to retract a bolt 323 from engagement with the door frame (not shown) and the door 302 is free to open. A further description of the inventive bolt mechanism 321 of the present invention will be provided below.

Also inside the circumference of the support housing 303 is located a control board 318 including a processor unit for controlling the electronic operation of the device. The control board 318 can include the processor, as well as memory and controller elements for receiving the input data, storing comparison data and processing, analyzing and comparing input data with stored data. A connector 319 links the electronic components of the door knob and facilitates the electromechanical functioning of the door locking apparatus. The connector 319 is also provided within the support housing 303 for connecting to and activating a solenoid 325 when an appropriate match between stored data and acquired data is accomplished. The connector 319 may be integral and directly connected to the control board 318 or may be a separately connected hardware component.

The solenoid 325 for actuating the locking and unlocking function of the locking mechanism is accordingly connected to the connector 319 and also positioned within the circumference of the support housing 303. When an appropriate signal via the connector 319 is received, the solenoid 325 actuates a switch 327 for placing the door locking apparatus 301 into an unlocked state and also provides for returning the door locking apparatus 301 to the locked state, for example after a set period of time. As the solenoid 325 and its respective electro-mechanical structure and function is well known in the art, no further discussion is provided.

The important issue with respect to including all of the electrical and electro-mechanical parts within the circumference of the substantially cylindrical housing of the door handle support 303, is the savings of space and weight accommodated thereby as well as the ability to reduce the size of the body portion 306 of the door locking apparatus 301 and, in fact, the very overall size of the door locking apparatus 301 itself. As seen in FIG. 16B the control board 318 is slid into a receiving slot within the support housing 303, as is the connector 319 and solenoid 325 immediately surrounding the actuator shaft 307. Incorporating the noted electronic and electromechanical devices of the present invention, all within the support housing 303, has led to the necessity and critical nature of the further inventive aspects of the present invention as described below to provide novel and compact mechanical components which still permit the efficient operation of the door and door locking apparatus 301.

As previously described in this application, data is stored in a memory which may be located on or in communication with the control board 318 and in order to unlock the apparatus 301, a user inputs a fingerprint to the door handle sensor which is compared with the stored data in the control board 318. Where the processor and control board 318 note a positive match of the user's fingerprint with the stored data, a signal is sent via the connector 319 for actuating the solenoid 325 to unlock the door locking apparatus 301 in the manner as described below.

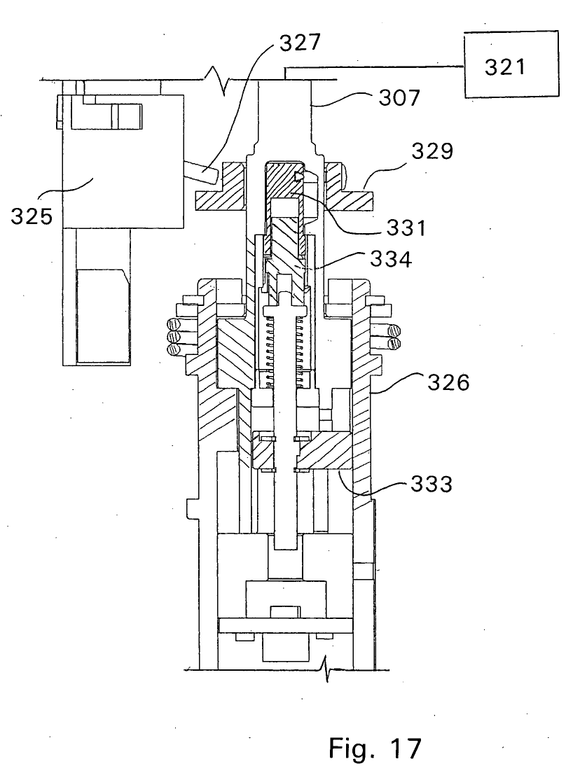

Observing FIG. 17, and by way of further explanation and detailed description, the solenoid 325 has a switch 327 which upon actuation, contacts an axially movable actuator ring 329 which axially displaces a gear 333 connected with the actuator shaft 307. The gear 333 is linearly moved by the actuator ring 329 between two positions; a locked position and an unlocked position. In the door locked position the gear 333 is not engaged with the door handle support 326. Thus, the door knob or handle 310, which is connected to the door handle support 326 merely rotates without connection to, or without causing rotation of the actuator shaft 307. Axially moving the gear 333 into engagement with the door handle support 326 as seen in FIG. 17 permits the actuator shaft 307 and door handle 310 to rotate together relative to the support housing 303 and operate a bolt mechanism 321 connected to the actuator shaft 307 and open the door 302. and thus the door is unlocked.

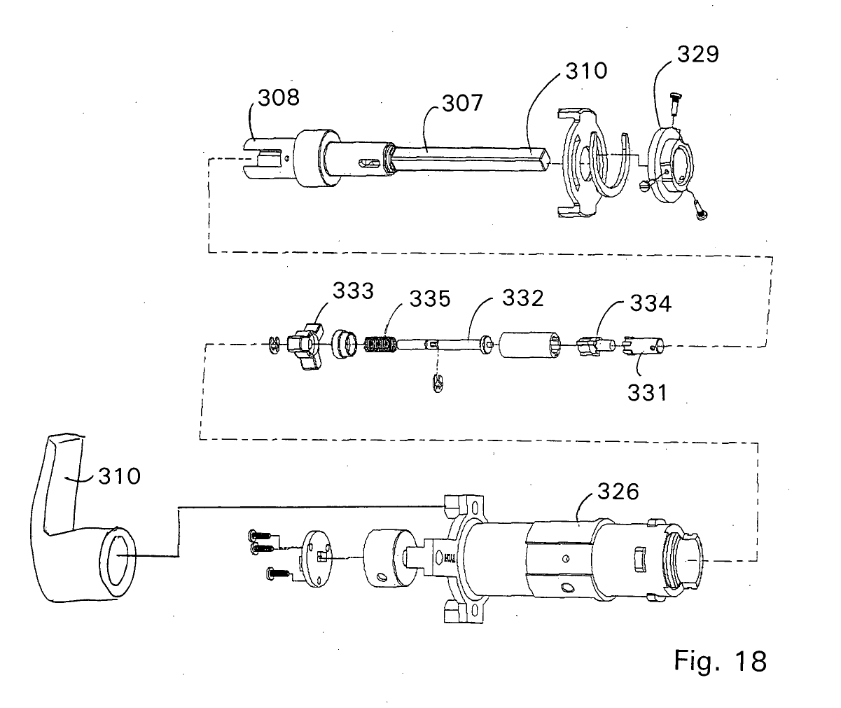

Turning to FIG. 18, the actuator shaft 307 has a first end 308 for engaging via the gear 333 with the door handle support 326 and hence a respective door handle 310 in a non-rotatable manner, i.e., the first end 308 is connected with the door handles, knobs or levers so as to rotate therewith when unlocked. An intermediate portion of the actuator shaft 307 supports a plurality of axially spring biased locking and unlocking components, and a second end 310 is connected to the bolt mechanism 321, as described below. The actuator shaft 307 is rotatably, and interlockably supported within the door handle support 326 which is connected to the door knob or handle 310, so that the handles, knobs or levers 310 and the actuator shaft 307 rotate the actuator shaft 307 relative to the support housing 303 when in an unlocked state.

The axially spring biased locking and unlocking components include at a minimum the actuator ring 329, described above as being contacted by the solenoid switch 327, an actuator ring follower 331, an intermediate follower 334, a pin 332 an actuator gear 333, and a biasing spring 335. The actuator ring 329, ring follower 331, pin 332 and actuator gear 333 are axially supported relative to the actuator shaft 307. Importantly, the gear 333 is non-rotatably connected to the actuator shaft 307 so as to cause rotation of the actuator shaft 307 when in the unlocked state and, correspondingly, does not rotate the actuator shaft 307 in the locked position. In other words, if the gear 333 on the actuator shaft is not engaged with the door handle support 326, the actuator shaft 307 cannot turn.

The gear 333 and other components are axially moveable relative to the actuator shaft 307. The biasing spring 335 presses the pin 332 in an axial direction relative to the actuator shaft 307 into contact with the intermediate follower 334 and the ring follower 331 so as to maintain a springable bias on these components and the ring follower 329.

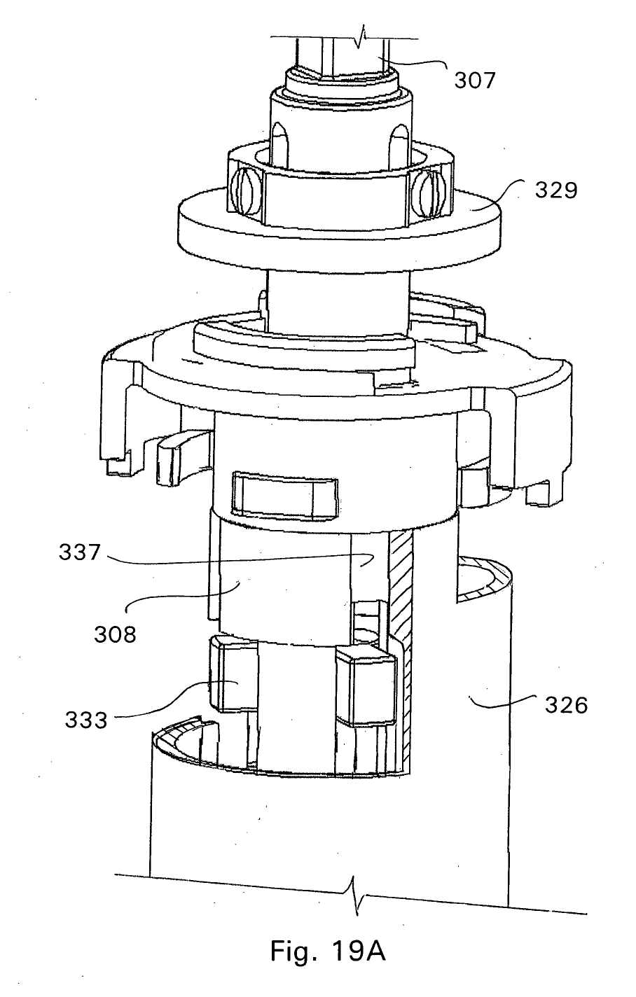

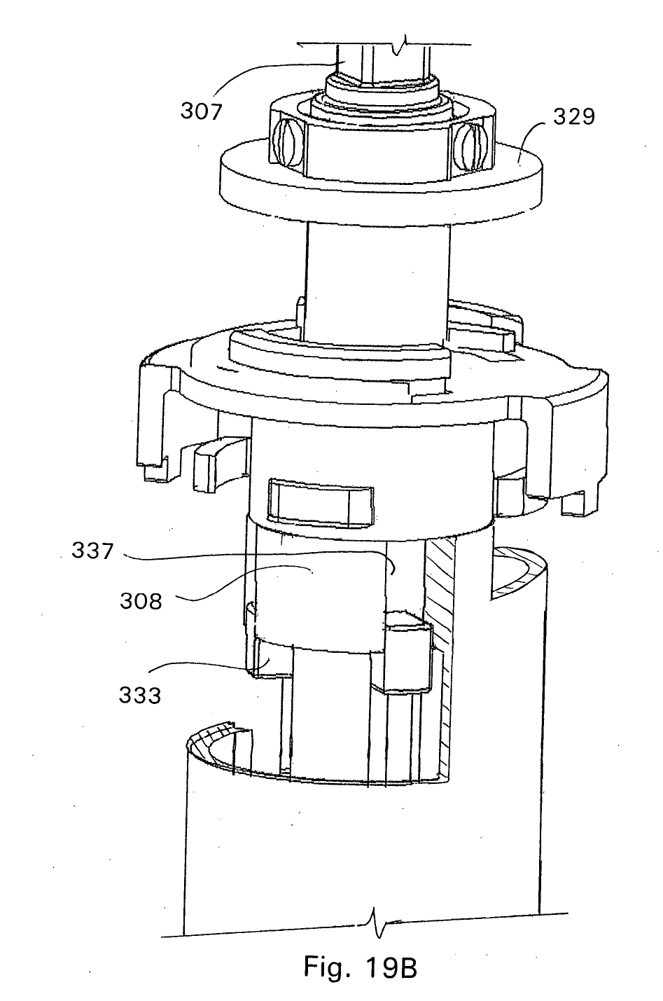

From either the locked state or the unlocked state, when the solenoid 325 is actuated the switch 327 contacts the actuator ring 329 and moves the supported components against the axial bias of the spring 335 to achieve either the subsequent locked or unlocked state. For example, as seen in FIGS. 19A-B where the door locking apparatus 301 is initially in an locked state as in FIG. 19A so that the gear 333 does not engage with the handle support 326, the solenoid 325 actuates the switch 327 and the components are axially moveable relative to the actuator shaft 307 so that the actuator gear 333 is moved into engagement with a corresponding spline or gear slots 337 defined by the door handle support 326 and the end 308 of the actuator shaft 307, and into an unlocked state, as shown in FIG. 19B. On the other hand, where the door locking apparatus 301 is initially in the unlocked state, as in FIG. 19B, the solenoid 325 actuates the switch 327 and the components are again axially moveable relative to the actuator shaft 307 so that the actuator gear 333 is disengaged from the corresponding gear slots or spline 337 defined by the support 326 and the actuator shaft end 308.

The door handle support 326 is provided with teeth at least partially defining the gear slots or spline 337 to engage the actuator gear 333 in the unlocked state. The support 326 is generally also tubular, but with a smaller radius than the support housing 303 and is as shown in FIG. 18 also fixed to support the door handle, knob or lever 310 for relative rotation therewith. As can be appreciated, where the biasing spring 335 axially biases the actuator gear 333 into engagement with the gear slots or splines 337, because the actuator gear 333 is rotatably attached with actuator shaft 307, both the actuator gear 333, and the actuator shaft 307 can now rotate with the door handle support 326, hence the unlocked state of the mechanism is achieved.

When the actuator ring 329 is contacted by the solenoid switch 327, the actuator ring 329 pushes the follower 331, pin and actuator gear 333 between a first and a second axial position. From the first axial position in an unlocked state of the apparatus, the actuator ring 329 pushes against the bias of the spring 335 and moves the actuator gear 333 out of engagement with the gear slots or internal spline 337 defined by the actuator end 308 and the door handle support teeth on the inner surface thereof, to achieve a locked state of the mechanism and a second axial position of the gear 333. With the actuator gear 333 now axially moved out of engagement, as seen in FIG. 19A, the gear 333, follower 331, ring and actuator shaft 307 itself cannot now rotate with the door knob, handle or lever 310 where such action is performed by the user.

It is to be noted that with the solenoid 325 having actuated the actuator into the unlocked state of the apparatus, the actuator gear 333 is maintained in engagement with the gear slots or spline 337 for a desired period of time. The switch 327 can again return the above noted components to the locked position, for instance, after a certain predetermined time period upon an instruction from the connector 319 causing the solenoid 325 to again actuate the actuator ring 329 to allow the spring 335 to axially move the ring 329, follower 331 and gear 333 back to the locked state where the actuator gear 333 is once again disengaged with the internal fixed gear or spline 337.

The actuator ring 329, ring follower 331 and gear 333 may be maintained in either the first or the second axial positions and the respective locked or unlocked state until the actuator ring 329 is influenced again by the solenoid 325. The components are maintained in the second axial position and unlocked state by an axial position locking mechanism as described below.

The axial position locking mechanism, as best seen in FIG. 18, is formed by the ring follower 331 which is provided with a cavity which axially engages with an axial protrusion of an intermediate ring follower 331. The intermediate ring follower 331 also has a series of radial protrusions defining a first set of axially oriented, angled surfaces. The protrusions are sized to engage in slots on a crenelated internal bore of a sleeve part supported within the actuator shaft 307. The crenelated bore of the sleeve part has on one end thereof a second set of angled, axially facing surfaces, facing in the opposite direction, but parallel to the first axially facing surfaces on the intermediate follower.

In the unlocked state of the door, the angled faces of the intermediate ring follower 331 are pushed out of the slots in the sleeve and due to the biasing of the spring 335 slide up into contact with the opposites axial facing surfaces on the end of the sleeve part. The faces slide along one another until at least a radially facing edge stops the relative sliding of the first set of angled surfaces on the intermediate follower on the opposing axial surfaces of the sleeve. The intermediate follower is now held against the radially facing edge and the angled surfaces of the sleeve edge by the bias of the spring 335.

Operation of the solenoid switch 327 against the follower ring causes the ring follower 331 to push the first set of axially oriented angled surfaces on the intermediate ring follower 331 axially out of contact with the angled surfaces and the radial stop edge on the end of the sleeve. A second set of axially oriented angled surfaces on the sleeve directs the protrusion and axial face on the intermediate follower back into the axial slots in the sleeve. This permits the spring 335 to push the intermediate follower axially back up the sleeve and thus permit the pin, and the gear 333 thereon to be axially biased into their respective slots 337 as defined by the door handle support 326 and actuator shaft end 308.

This structure and arrangement permits the use of only a single solenoid 325 for axially moving the gear 333 between respective locked and unlocked states of the door lock apparatus. A sensor may also be provided which is contacted by the movement of the pin when the pin is moved from a first position to a second position, or the second position to the first position, the sensor can be connected to associated visual electronic which indicate the locked or unlocked state of the actuator and, i.e., the door.

Turning now to FIGS. 20A, 20B, the actuator shaft 307 extends into contact with the bolt mechanism 321 which is comprised of a number of plates and cams which influence a spring biased bolt 323 from a normally extended position for engagement with an appropriate detent in a door frame (not shown), into a retracted state substantially within the door 302 which, as is well known in the art, permits the door 302 to be rotated on its hinges relative to the door frame between an open and shut position. The bolt mechanism 321 specifically includes a front plate 341 and back plate 343 supporting an internal slide plate 345 which slides in a linear manner relative to the front and back plates 341, 343. The linear extension and retraction distance of the slide plate 345 relative to the front and back plates 341, 343 is shown between FIGS. 20A-B where the front plate 341 is removed for purposes of clarity and is generally equivalent to the necessary distance to substantially retract the bolt 323 from engagement with the detent in the door frame, i.e., a linear distance of about ¼ of an inch to 1 inch and more preferably about ½ of an inch.

As can be appreciated, the rotational movement of the actuator shaft 307 must be translated into the linear movement of the slide plate 345 by at least a first cam wheel 347 also supported between the front and back plates 341, 343 of the bolt mechanism 321. The cam wheel 347 is connected to the actuator shaft 307 via aperture 351, and the cam wheel 347 has a slide contact point radially spaced from the aperture 351 which contacts the slide plate 345 to produce the linear movement of the slide plate 345. In a preferred embodiment a second cam wheel 349 may be provided also sandwiched between the front and back plates 341, 343 to actuate the slide plate 345. The two spaced apart cam wheels are necessary to accommodate different handle support axis distances from the edge of the door, i.e., a different bolt length within the door, but each cam wheel performs the similar function of actuating the slide plate 345 and retracting the bolt 323 upon rotation.

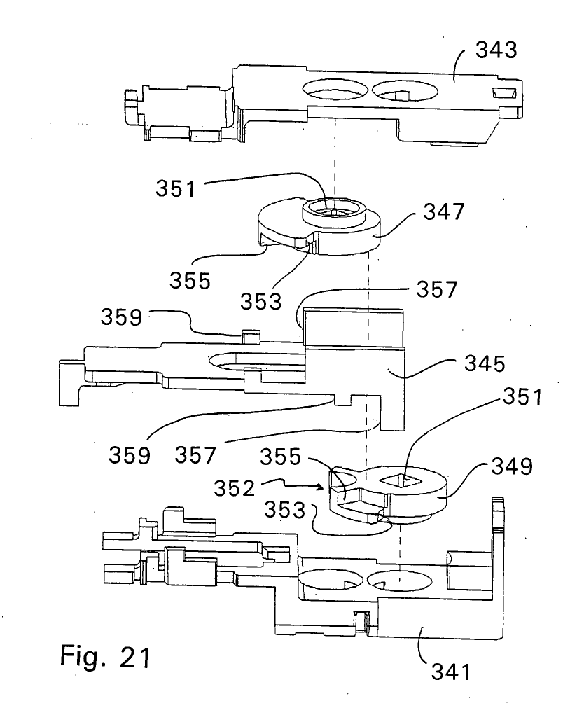

Turning to FIG. 21, the cam wheels 347, 349 are offset from one another on either side of the slide plate 345 so that the center openings or apertures 351 of the offset cam wheels are linearly spaced from one another in order for the bolt mechanism 321 to accommodate different sized bolt lengths in accordance with known sizing of door handles 310 on a door 302. For example, where the distance from the axial center of the door handle 310 is greater from the edge of the door 302, the actuator shaft 307 is inserted through the aperture 351 of the cam wheel spaced farthest from the door 302.

In an opposite manner, where the door 302 and door handle 310 is supported on the door 302 closer to the door edge, the actuator shaft 307 extends through the cam wheel aperture 351 closest to the door edge. In either event, the actuator shaft 307 is connected with one of the cam wheels to translate the rotational motion of the actuator shaft 307 into linear movement of the slide plate 345. Because of the compactness of the mechanics, the cam wheels may, in fact, radially overlap so that a radial notch 352or indentation is provided in at least one of the cam wheels to permit the actuator shaft 307 to be inserted in one or the other of the apertures 351 without interfering with the other.

In order to provide the appropriate translation of rotary motion to linear motion, each of the cam wheels 347, 349 is provided with at least a first pair of cam surfaces, i.e., a leading cam surface 353 and a following cam surface 355 circumferentially spaced from the leading cam surface 353. The circumferentially spaced cam surfaces 353, 355 permit the cam wheels to have a significantly smaller diameter, and importantly also to permit a significantly smaller diameter actuator shaft 307 while still providing the appropriate linear movement to the slide plate 345. Thus, these components can be made very small and take up significantly less space in the locking mechanism to make room for all the mechanical, electrical and electromechanical parts in the present invention.

In other words, these small cams 347, 349 are provided with a first and second circumferentially spaced cam surfaces 353, 355 in order to produce a complete range of linear actuation of the slide plate 345 to fully retract the bolt 323. The leading and following cam surfaces 355 face in the same circumferential direction and may be spaced apart about 20-60 degrees and more preferably about 45 degrees apart.

In order to ensure that the bolt 323 is retracted no matter which way the door handle, knob or lever 310 is turned, each cam wheel 347, 349 may be provided with an oppositely facing second pair of cam surfaces circumferentially spaced from the first pair of cam surfaces, but facing in an opposite circumferential direction. This arrangement as discussed in further detail below, permits either a counter clockwise or clockwise rotation of the door handle, knob or lever 310 to operate the bolt mechanism 321.

The slide plate 345 is generally biased in an extended position relative to the front and back plates 341, 343 by either a spring (not shown) directly biasing the slide plate 345 or the spring biasing the bolt 323 into the extended position. With this in mind, each side of the slide plate 345 is provided with at least a first pair of follower edges consisting of a linearly spaced apart first follower edge 357 and a second follower edge 359. A pair of such follower edges may be provided on both top and bottom portions of the slide plate 345 so as to engage with a respective pair of first and second cam surfaces 353, 355 as described above, in order to facilitate the same linear movement of the slide plate 345 no matter which way the door handle, knob or lever 310 is rotated. For purposes of clarity, the following discussion will describe the interaction between one pair of cam surfaces on a cam wheel and the respective pair of follower edges on the slide plate 345.

The cam wheel 347, 349 is turned by a user rotating the actuator shaft 307 and the device is in an unlocked state, as described above. The actuator shaft 307 is inserted and non-rotatably connected through the aperture 351 so as to cause direct rotation of the respective cam wheel 347, 349. From the extended bolt 323 and bolt mechanism 321 position as shown in 20B, the user turns the door handle 310, the actuator shaft 307 turns the cam wheel 347, the first cam surface 353 follows a substantially circular path and engages the first follower edge 357 of the sliding plate. The first cam surface 353 pushes the first follower edge 357 for a portion of the total linear distance which the slide plate 345 must travel to retract the bolt 323. Due to the circular path of the first cam surface 353 and the small diameter of the cam wheel, the first cam surface 353 will fall off the follower 357 before the bolt 323 is completely retracted, i.e., become disengaged with the sliding plate at some point prior to full retraction of the bolt 323. To address this issue, prior to the leading or first cam surface 353 disengaging from contact with the first follower edge 357, the second or following cam surface 355 engages the second follower edge 359 on the slide plate 345 even as the first cam surface disengages from the first follower edge 357. The second following cam surface 355 thus provides continued linear movement of the slide plate 345 according to further rotation of the actuator shaft 307 and permits the bolt 323 to be fully retracted despite the limited diameter of the cam wheel 347 which causes the first cam surface 353 to fall off the respective first follower edge 357.

In other words, because of the small size, i.e., limited diameter of the cam, the first leading cam surface 353 contacts the following edge 357 for only a portion of the entire linear distance which the slide 345 must be moved in order to appropriately retract the bolt 323. The second following cam surface 355 contacts the respective second linear cam follower edge 359 farther along on the slide and is thus able to continue to linearly push or finish pushing the slide into its farthest linear retracted position thus fully retracting the bolt 323 within the door so as to allow the door to open.

Once having opened the door, when the user releases the door handle, knob or lever 310, the spring biased bolt 323 or slide plate 345 pulls the slide plate 345 so that, in a manner opposite to that described above, the follower edges 357, 359 of the slide plate 345 move the first and second cam surfaces 353, 355 of the cam wheels back to their initial position where the bolt 323 extends from the door and is available to again engage the detent in the door frame.

Since certain changes may be made in the above described improved door locking apparatus 301, without departing from the spirit and scope of the invention herein involved, it is intended that all of the subject matter of the above description or shown in the accompanying drawings shall be interpreted merely as examples illustrating the inventive concept herein and shall not be construed as limiting the invention.

Wherefore, I/We claim:

1. A door locking apparatus comprising:
a user verification system for receiving input data from the user comprising;
a memory for storing comparison data;
a processor for comparing received input data with the stored comparison data and producing an output instruction;
a controller for actuating a switch according to the output instruction;
a locking and unlocking mechanism controlled according to the actuation of the switch, the locking and unlocking mechanism comprising;
a gear, immovably retained against rotation around an axis by a fixed sleeve defining a locked state of the door locking apparatus, and an unlocked state of the door locking apparatus defined by axial displacement of the gear along the axis and out of engagement with the fixed sleeve; and
a bolt mechanism connected to the locking and unlocking mechanism for causing relative movement of a bolt between an extended and retracted positions.

2. The door locking apparatus as set forth in claim 1 wherein the bolt mechanism further comprises a linear slide connected to the bolt, the linear slide actuated by a cam in relative rotatable cooperation with the gear in the locked and unlocked state of the apparatus.

3. The door locking apparatus as set forth in claim 2 wherein the cam is provided with a first and second radially spaced cam surfaces for engaging a respective first and second linearly spaced following surfaces on the linear slide.

4. The door locking apparatus as set forth in claim 3 further comprising an actuating rod connected to a door handle extending through an aperture in the cam to cause the relative rotation of the cam and operation of the linear slide and bolt when the door locking apparatus is in the unlocked state and the user rotates the door handle.

5. The door locking apparatus as set forth in claim 2 wherein the bolt mechanism is actuated by at least one of a first and a second cams positioned on opposing sides of the linear slide wherein each of said first and second cams are provided with the first and second radially spaced cam surfaces for engaging respective first and second linearly spaced following surfaces on the opposing sides of the linear slide.

6. The door locking apparatus as set forth in claim 5 wherein the first and second cams each comprise an aperture defining axially parallel actuating axis for receiving an actuating rod connected to a door handle.

7. The door locking apparatus as set forth in claim 1 further comprising an actuating shaft connecting between a door handle and the bolt mechanism wherein the actuating shaft is non-rotatably connected to the gear.

8. The door locking apparatus as set forth in claim 7 wherein the gear is axially displaceable relative to the actuating shaft.

9. The door locking apparatus as set forth in claim 8 wherein the gear is biased by a spring into engagement with the fixed sleeve in the locked state and the switch linearly displaces the gear against the spring bias and out of engagement with the fixed sleeve into the unlocked state of the door locking apparatus.

10. The door locking apparatus as set forth in claim 9 wherein the gear is maintained in the unlocked state by an axially facing surface supported on a rotatably and linearly fixed housing element of the actuator shaft.

11. A door locking apparatus comprising:
a user verification system for receiving input data from the user comprising;
a memory for storing comparison data;
a control board having a processor for comparing received input data with the stored comparison data and producing an output instruction;
a controller for actuating a solenoid switch according to the output instruction;
a locking and unlocking mechanism controlled according to the actuation of the solenoid switch; and
wherein at least the control board of the user verification system as well as the solenoid switch and the locking and unlocking mechanism are all arranged in the door locking apparatus within a radius defined by a circumference of a supporting aperture formed in a door.

12. The door locking apparatus as set forth in claim 11, wherein the user verification system further comprises a biometric fingerprint scanning plate for receiving the input data as a user's fingerprint.

13. The door locking apparatus as set forth in claim 12, wherein at least the user's fingerprint is stored as comparison data

14. The door locking apparatus as set forth in claim 13, wherein a positive match is determined between the user's fingerprint and the comparison data in the processor and an output instruction to the controller causes the solenoid switch to actuate the locking and unlocking mechanism into one of a locked and an unlocked state.

15. The door locking apparatus as set forth in claim 11 comprising an actuator shaft connecting a door handle and the bolt mechanism along an axis of rotation wherein the locked state of the locking and unlocking mechanism is defined by an engagement element non-rotatably connected with the actuator shaft and axially spring biased into a rotatably fixed position with the circumferential housing of the door locking apparatus to prevent relative rotation of the actuator shaft and door handle relative to the housing of the door locking apparatus.

16. The door locking apparatus as set forth in claim 15 wherein the unlocked state of the locking and unlocking mechanism is defined by the engagement element non-rotatably connected with the actuator shaft being axially moved relative to the actuator shaft against the spring bias and out of engagement with the circumferential housing of the door locking apparatus to permit relative rotation of the actuator shaft and door handle relative to the housing of the door locking apparatus.

17. A door locking apparatus comprising:
a user verification system for receiving input data from the user comprising;
a memory for storing comparison data;
a control board having a processor for comparing received input data with the stored comparison data and producing an output instruction;
a controller for actuating a solenoid switch according to the output instruction;
a locking and unlocking mechanism controlled according to the actuation of the solenoid switch;
at least the control board of the user verification system as well as the solenoid switch and the locking and unlocking mechanism are all arranged in the door locking apparatus within a radius defined by a circumference of a supporting aperture formed in a door; and
a bolt connected to the locking and unlocking mechanism by a linear slide for causing relative movement of the bolt between an extended and retracted position and the linear slide actuated by a cam in relative rotatable cooperation with an actuator shaft of the locking and unlocking mechanism; and
wherein the cam is provided with a first and second radially spaced cam surfaces for engaging a respective first and second linearly spaced following surfaces on the linear slide to retract the bolt against a spring biased extended position.

18. The door locking apparatus as set forth in claim 17 wherein when the actuator shaft is rotated by operation of the door handle, the first cam surface engages the respective first following surface on the linear slide and subsequently after a predetermined angle of rotation the second cam surface engages the respective second following surface on the linear slide such that the linear slide is uninterruptedly linearly displaced to an extent necessary to adequately retract the bolt.

19. The door locking apparatus as set forth in claim 18 wherein a second axially displaced cam is provided on the second side of the linear slide, the second axially displaced cam also having a first and second radially spaced cam surfaces for engaging a respective first and second linearly spaced following surfaces on the opposing side of the linear slide to retract the bolt against a spring biased extended position.
